(19) United States
(12) Patent Application Publication
(10) Pub. No.: US 2020/0312180 A1
(43) Pub. Date: Oct. 1, 2020

(54) ACADEMIC LANGUAGE TEACHING MACHINE

(71) Applicant: Cetati Inc., Moraga, CA (US)

(72) Inventor: Edward Manfre, Camarillo, CA (US)

(21) Appl. No.: 16/828,875

(22) Filed: Mar. 24, 2020

Related U.S. Application Data
(60) Provisional application No. 62/826,046, filed on Mar. 29, 2019.

(51) Int. Cl. G09B 7/08

(52) U.S. Cl. CPC G09B 7/08; G09B 19/025

(57) ABSTRACT

A teaching server computer system implements a teaching strategy developed by experts and uses that strategy to teach humans one or more academic languages to fluency. In a first teaching phase, the teaching server teaches the student a vocabulary selection from the academic language in the absence of any definitions of terms to the student, instead using these terms in prompts to the student and responding positively to only correct responses by the student that evidence a proper understanding of the terms. In a second teaching phase, the teaching server uses an adventure story or game that follows actions taken by the student which uses, and detects the student's proper to understanding of, terms of the subject academic language in the absence of definitions for those terms.

### CROSS REFERENCE TO RELATED APPLICATION

This Non-Provisional U.S. Application claims priority to U.S. Provisional Application No. 62/826,046 filed on Mar. 29, 2019, of the same title, which is incorporated by reference herein for all purposes.

### FIELD OF THE INVENTION

The present invention relates generally to artificially intelligent computer systems, and, more particularly, to a computer-implemented teaching machine to make human students fluent in an academic language.

### BACKGROUND OF THE INVENTION

Understanding and speaking the terms and phrases used in an academic language (academic language fluency), even at a basic level such as Kindergarten-level math, is essential for learning that subject. Since, currently, all teaching is through language, fluency in an academic language (e.g., mathematics, science, engineering, technology and social studies) is absolutely essential to learning the corresponding academic subject matter.

For example, the most recent international tests (e.g., the Programme for International Student Assessment: 0PISA) show about half of participating countries are about the same or worse as the U.S. in math proficiency, where only ⅓ are proficient in math and the remaining ⅔, including the U.S. are not. The 2017 Nation's Report Card shows that two-thirds of eighth graders in the U.S. are not proficient in math. More than half of U.S. students entering 2-year colleges need to take at least one developmental course because they are not ready for college-level math.

These unfortunate statistics stem in large part from a lack of fluency in academic language, in this example, math language. This academic language deficiency tends to begin before children reach school age. As is the case with language in general, not all children are raised with adequate exposure to natural math vocabulary and usage. Too many enter school lacking the verbal understanding they need to learn academic subjects such as math. It is almost impossible to learn a subject if you cannot understand the teacher or the textbook (or any other educational materials, print or digital). Tragically, once students fall behind in Kindergarten or any time after, they tend to fall further behind.

Teaching academic language to children and adults who are behind is no easy task. Such teaching takes time and expertise and involves active use of the language, particularly through purposeful conversation in which feedback and prompts make the most of the conversation. Few experts, including some parents and teachers, have the knowledge and skills to effect such teaching. Thus, only a very small percentage of students are getting the help they sorely need in developing fluency with academic languages.

What is needed is a way to make the expertise of the few experts available to a large portion of the population to teach academic language fluency to enable greater academic achievement.

### SUMMARY OF THE INVENTION

In accordance with the present invention, a teaching server computer system implements a teaching strategy developed by experts and uses that strategy to teach humans one or more academic languages to fluency. By implementing expert teaching techniques in a teaching server computer system, the teaching can scale to teach academic languages to numerous students with only reasonable resources.

In a first teaching phase, the teaching server implements a teaching technique that is modeled after the way people learn a natural language outside of school, e.g., typically before reaching school age. The teaching server teaches the student a vocabulary selection from the academic language that the teaching server is configured to teach. The teaching server teaches this vocabulary selection in the absence of any definitions of terms to the student, instead using these terms in prompts to the student and responding positively to only correct responses by the student that evidence a proper understanding of the terms.

In a second teaching phase after the student has demonstrated understanding of the terms of the vocabulary selection, the teaching server implements additional teaching techniques that are also modeled after the way people learn a natural language outside of school. This second teaching phase takes the form of an adventure story or game. The story includes a narrative through-line and, like a game, follows actions taken by the student. Similar to the first teaching phase, the teaching server uses, and detects the student's proper understanding of, terms of the subject academic language in the absence of definitions for those terms.

Note that the various features of the present invention described above may be practiced alone or in combination. These and other features of the present invention will be described in more detail below in the detailed description of the invention and in conjunction with the following figures.

### A BRIEF DESCRIPTION OF THE DRAWINGS

In order that the present invention may be more clearly ascertained, some embodiments will now be described, by way of example, with reference to the accompanying drawings, in which:

FIG. 1 shows an academic language teaching system in which a teaching server teaches human students academic language fluency using a student device in accordance with the present invention;

FIG. 2 is a block diagram of the teaching server of FIG. 1 in greater detail;

FIG. 3 is a block diagram of interactive teaching logic of the teaching server of FIG. 2 in greater detail;

FIG. 4 is a block diagram of lesson data of the teaching server of FIG. 3 in greater detail;

FIG. 5 is a logic flow diagram illustrating teaching of an academic language through a narrative story in accordance with the present invention;

FIG. 6 is a logic diagram of a step of FIG. 5 in greater detail;

FIG. 7 is a partial screen view of a prompt presented to the student by the teaching server of FIG. 1;

FIGS. 8-11 each show prompts furthering a narrative story in the teaching of an academic language by the teaching server of FIG. 1 in accordance with the present invention; and

FIG. 12 is a block diagram of the teaching server of FIG. 1 in greater detail.

### DETAILED DESCRIPTION OF THE INVENTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

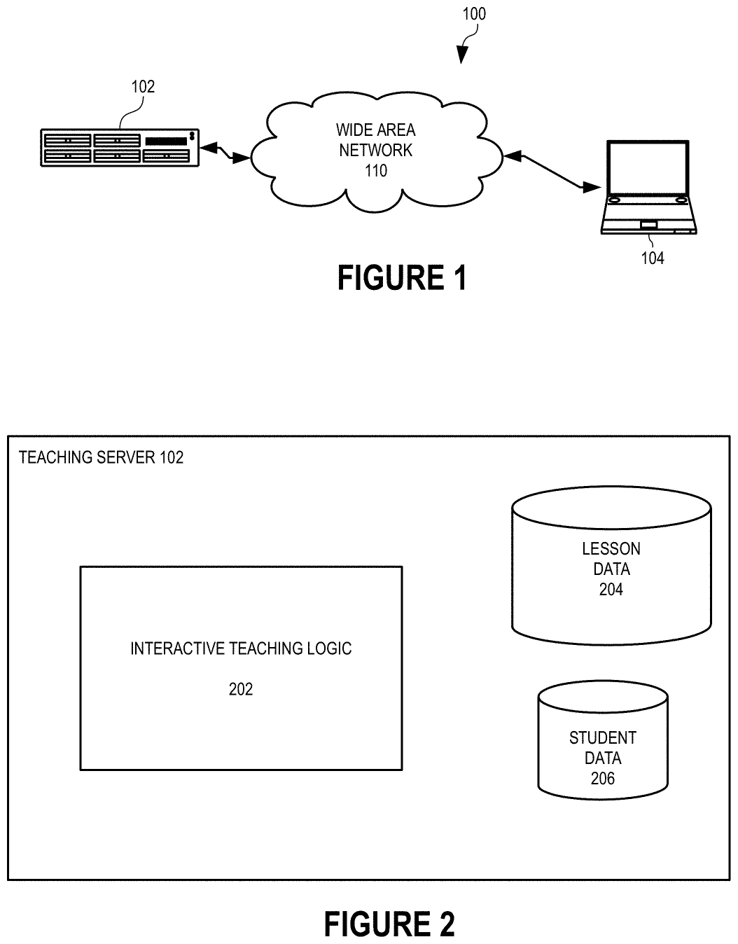

In accordance with the present invention, a server computer system (teaching server 102—FIG. 1), that implements a teaching strategy developed by experts, uses that strategy to teach humans one or more academic languages to fluency. Teaching server 102 is coupled to student device 104 through a wide area network (WAN) 110, which is the Internet in this illustrative embodiment. While a single teaching server 102 is shown, it should be appreciated that the features and behavior of teaching server 102 described herein can be distributed among multiple computers, physical and virtual. In addition, for simplicity and clarity, a single student device 104 is shown. However, it should be appreciated that teaching server 102 can teach numerous students through numerous student devices simultaneously. In fact, a significant advantage of teaching server 102 is this very ability: to scale as needed to serve as many students as need to be taught.

Teaching server 102 is shown in greater detail in FIG. 2 and in even greater detail below in FIG. 11. As shown in FIG. 2, teaching server 102 includes interactive teaching logic 202, lesson data 204, and student data 206.

Each of the components of teaching server 102 is described more completely below. Briefly, interactive teaching logic 202 conducts an interactive lesson with the subject student to increase fluency of the student in one or more academic languages in a manner described more completely below. Lesson data 204 specifies the content and flow of lessons executed by interactive teaching logic 202. Student data 206 tracks the progress and current lesson state of numerous human students taught by interactive teaching logic 202.

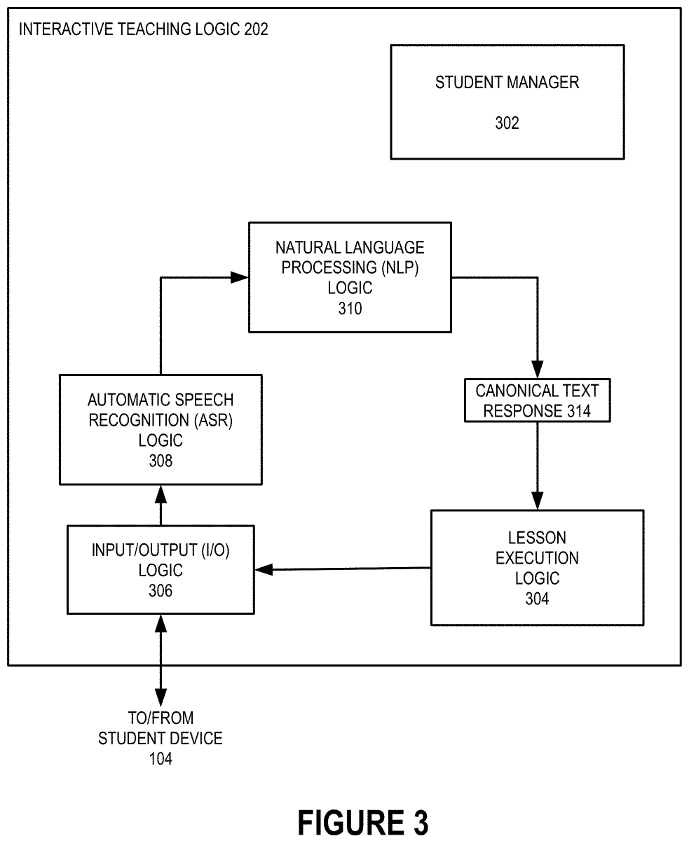

Interactive teaching logic 202 is shown in greater detail in FIG. 3. Student manager 302 manages student data 206, including such things as creation and management of student accounts, student authentication, reports of student performance, etc. Lesson execution logic 304 controls and effects teaching in the manner described below, determining what content should be presented to each student in response to actions taken by the students.

Upon determining which prompting information to present to the student, lesson execution logic 304 sends the data to input/output (I/O) logic 306. I/O logic 306 generates an audiovisual signal representing the prompting information and sends the audiovisual signal to student device 104 in a manner that causes student device 104 to present the audiovisual signal to the student. As used herein, an audiovisual signal can include a video signal and/or an audio signal. In alternative embodiments, the prompting information can be something other than an audiovisual signal, e.g., text.

In the interactive lesson with the student, student device 104 captures data representing a response of the student to the prompting information. In this illustrative embodiment, the captured data represents a captured audio signal of the student speaking in response to the prompting information. In alternative embodiments, the captured data can represent user interface actions such as clicking on one of multiple choices as a response to the presented prompt. Student device 104 can include conventional logic that both (i) presents audiovisual signals to the student and (ii), in response, captures an audio signal of the student's oral response. In this illustrative embodiment, this conventional logic is a conventional web browser. I/O logic 306 sends whatever additional conventional logic is needed to present the prompting information and capture the response through the conventional web browser of student device 104.

Upon receipt of the captured response data from student device 104 in this illustrative embodiment in which the capture response data is captured audio of the student speaking a response, I/O logic 306 sends the captured response data to automatic speech recognition (ASR) logic 308. ASR logic 308 derives a textual representation of the student's oral response from the captured response data. ASR logic 308 is conventional and known, in this illustrative embodiment, and is not described in greater detail herein. ASR logic 308 sends the textual representation of the student's response to natural language processing (NLP) logic 310.

NLP logic 310 includes known and conventional semantic models for attributing meaning to words and phrases in a natural language. NLP logic 310 produces, from the textual representation of the student's response, canonical text response 314. Canonical text response 314 represents the essence of the student's response in a distilled, simplified, canonical form that teaching machine logic 204 can understand.

To understand the nature of the simplified, canonical form, it is helpful to consider an example in which the student chooses option “A” of several choices. NLP logic 310 can produce canonical text response 314 of “A” from any of the following student responses received from ASR logic 308: “A, the first one”; “I think the answer is ‘A’”; and “A”.

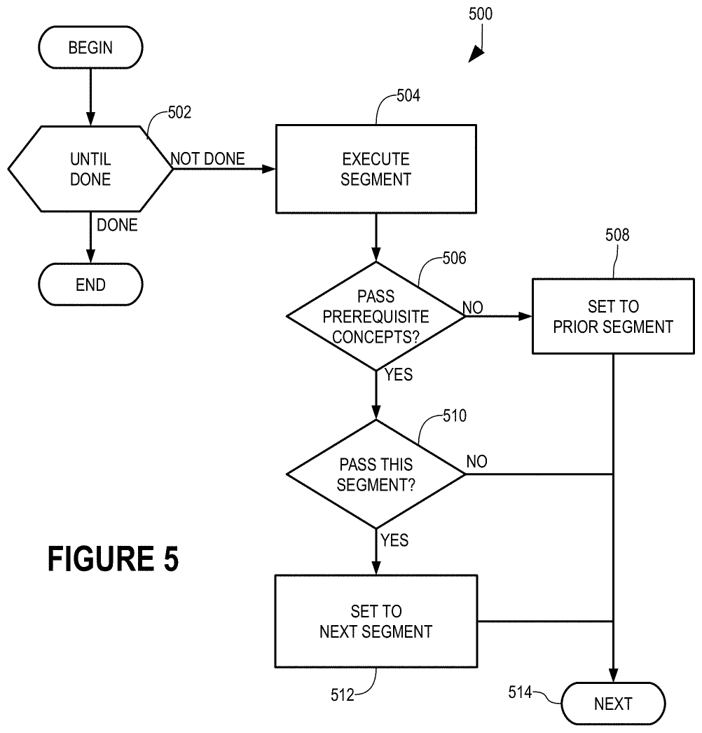

Lesson execution logic 304 receives canonical text response 314 from NLP logic 310 and, therefrom, determines the next action to take in execution of the lesson being given to the student. Lesson execution logic 304 makes this determination in the manner described below in conjunction with lesson data 204 (FIG. 2) and logic flow diagram 500 (FIG. 5).

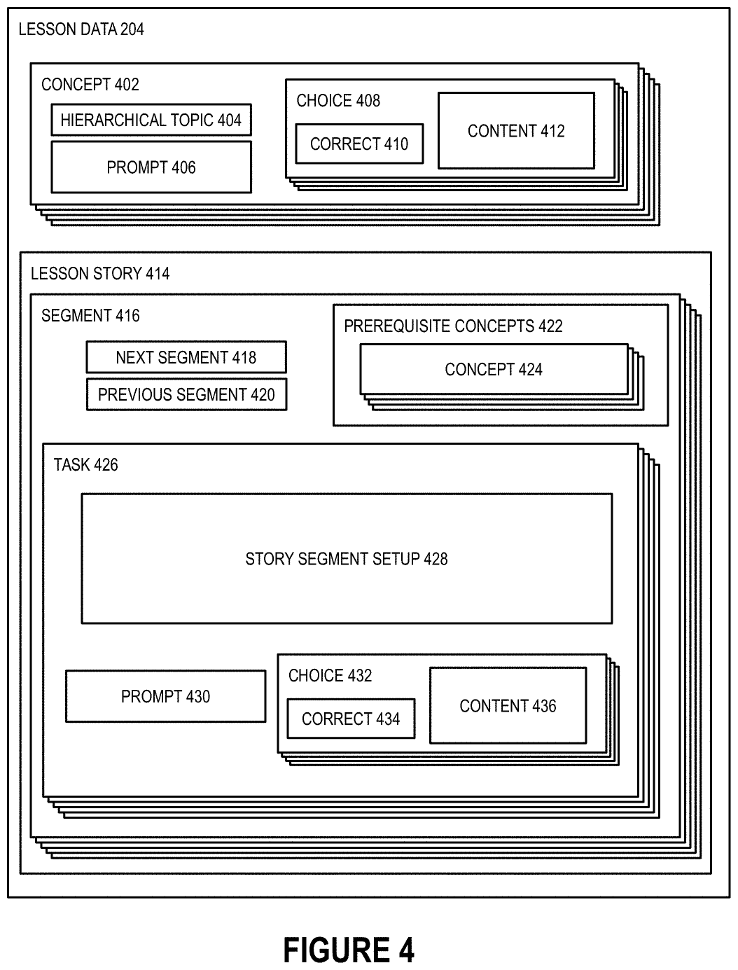

Lesson data 204 is shown in greater detail in FIG. 4. Most of the components of lesson data 204 are described below in the context of logic flow diagram 500 (FIG. 5), though some of these components are introduced here to facilitate appreciation and understanding of the present invention.

Lesson data 204 includes a number of academic language concepts 402 and a lesson story 414. Academic language concepts 402 each represents an individual component of academic language fluency. Hierarchical topic 404 identifies the topic of concept 402. For example, hierarchical topic 404 can specify that concept 402 pertains to the academic language of mathematics, the category of comparisons, and to the specific comparison of “less than.”

Lesson data 204 includes a lesson story 414 that represents a lesson cast in the form of a narrative story that includes a number of segments 416. While lesson data 204 is shown in this illustrative embodiment to include only a single lesson story 414, lesson data 204 can include numerous lesson stories that can be interconnected to form one or more curricula.

Loop step 502 and next step 514 define a loop in which lesson execution logic 304 processes segments 416 (FIG. 4) of lesson story 414 according to steps 504-512 until the lesson is deemed complete. The lesson can be deemed complete under any of a number of circumstances. The lesson can be deemed complete when a student has satisfactorily completed all of segments 416, when a student has demonstrated mastery of all of concepts 402 for one or more hierarchical topics 404, or when a student has passed an aptitude test of the subject matter to be taught to the student. During an interation of the loop of steps 502-514 (FIG. 5), the particular one of segments 416 (FIG. 4) processed by lesson execution logic 304 is sometimes referred to as the subject segment. Until the lesson is complete, processing by lesson execution logic 304 transfers from loop step 502 (FIG. 5) to step 504.

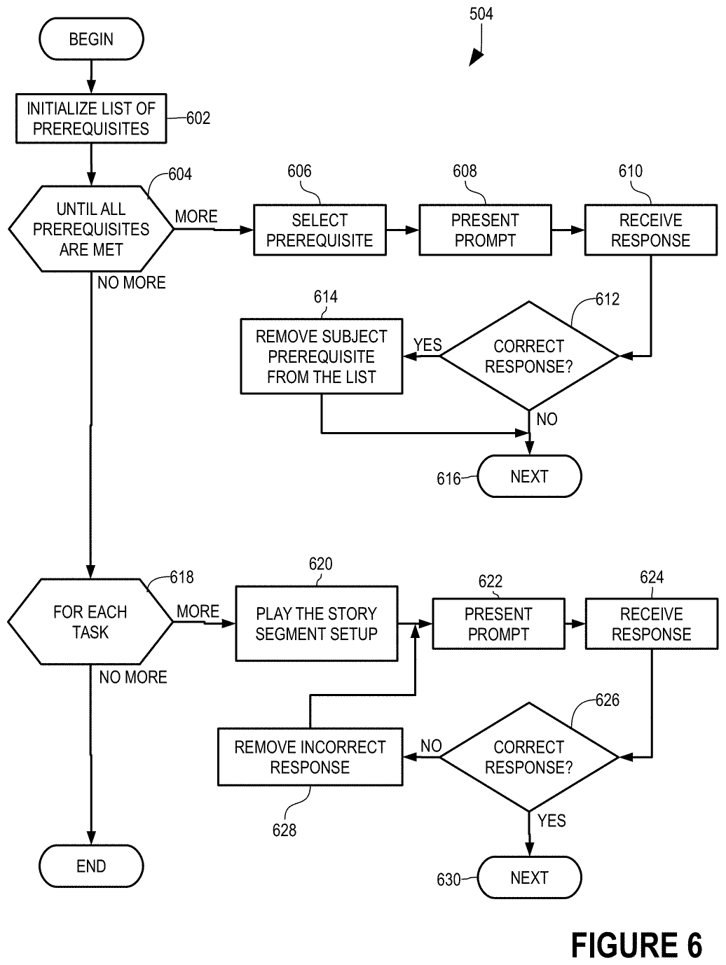

In step 504, lesson execution logic 304 executes the subject segment of the lesson. Step 504 is described in greater detail below in conjunction with logic flow diagram 504 (FIG. 6).

In test step 506, lesson execution logic 304 determines whether the student of the subject segment has pass all of prerequisite concepts 422 (FIG. 4) of the subject segment. Prerequisite concepts 422 includes a number of concepts 424, each of which identifies a corresponding one of concepts 402 that are designated as prerequisites for the subject segment. Concepts 402 are described more completely below. If the student was unable to master all of concepts 424 of prerequisite concepts 422, processing by lesson execution logic 304 transfers to step 508 (FIG. 5).

In step 508, lesson execution logic 304 sets the prior segment of lesson story 414 (FIG. 4) as the current lesson segment and transfers through next step 514 (FIG. 5) to loop step 502 to execute the prior lesson segment. Segments 416 (FIG. 4) of lesson story 414 are ordered. This order is represented in next segment 418 and previous segment 420. Next segment 418 identifies the next of segments 416 in the ordered sequence of lesson story 414. Previous segment 420 identifies the prior one of segments 416 in the ordered sequence of lesson story 414. In effect, segments 416 of lesson story 414 are a double-linked list. To set the prior segment of lesson story 414 as the current segment, lesson execution logic 304 sets the current segment to be the one identified by previous segment 420 of the subject segment.

Conversely in test step 506 (FIG. 5), if the student was able to master all of concepts 424 of prerequisite concepts 422, processing by lesson execution logic 304 transfers to test step 510 (FIG. 5). In test step 510, lesson execution logic 304 determines whether the student has passed the subject segment in the manner described below in the context of logic flow diagram 504 (FIG. 6).

If the student has passed the subject segment, lesson execution logic 304 sets the next segment of lesson story 414 as the current segment and processing transfers through next step 514 to loop step 502 and lesson execution logic 304 executes the next segment of lesson story 414. To set the next segment of lesson story 414 as the current segment, lesson execution logic 304 sets the current segment to be the one identified by next segment 418 of the subject segment.

Conversely, if the student has not passed the subject segment, processing by lesson execution logic 304 transfers from test step 510 through next step 514 to loop step in which lesson execution logic 304 repeats execution of the subject segment.

Thus, lesson execution logic 304 moves forward and backward through the ordered sequence of segments 416 (FIG. 4) of lesson story 414 until the student has passes all of segments 416.

As described above, step 504 (FIG. 5) in which lesson execution logic 304 executes the subject segment of lesson story 414 is shown in greater detail as logic flow diagram 504 (FIG. 6).

Steps 602-616 represent a first teaching phase and implement a teaching technique that is modeled after the way people learn a natural language outside of school, e.g., typically before reaching school age. Lesson execution logic 304 teaches the student a vocabulary selection from the academic language for which lesson execution logic 304 is configured to teach. Lesson execution logic 304 teaches this vocabulary selection in the absence of any definitions of terms to the student, instead using these terms in prompts to the student and responding positively to only correct responses by the student.

In step 602, lesson execution logic 304 initializes a list of prerequisites for the subject segment. In particular, lesson execution logic 304 initializes the list to include all of concepts 402 (FIG. 4) identified by concepts 424 of prerequisite concepts 422. Prerequisite concepts 422 represent the vocabulary selection lesson execution logic 304 is configured by segment 416 to teach.

Loop step 604 and next step 616 define a loop in which lesson execution logic 304 processes the list of prerequisite concepts according to steps 606-614 until the student has satisfied the prerequisites for the subject segment.

In step 606, lesson execution logic 304 selects one of concepts 424 as the subject prerequisite concept. Lesson execution logic 304 can select each of concepts 424 in a predetermined sequence or randomly.

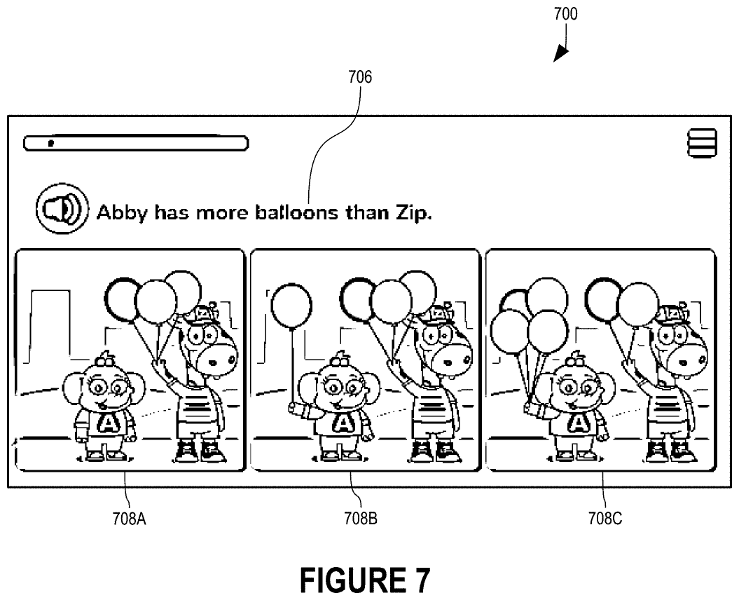

In step 608, lesson execution logic 304 presents the prompt of the subject prerequisite concept to the student. Each of concepts 402 includes a prompt 406 that can be presented to the student to assess whether the student understands concept 402. For example, prompt 406 can represent the question, “which picture shows that Abby has more balloons than Zip?” as shown as prompt 706 (FIG. 7). In this illustrative embodiment, concepts 402 (FIG. 4) represent multiple-choice tests for the student. Accordingly, the subject prerequisite concept includes a number of choices 408, each of which includes a correct flag 410 and content 412. Continuing in this illustrative example, each of choices 408 can include content 412 representing an image to be displayed to the student, e.g., images 708A-C (FIG. 7). The content 412 (FIG. 4) of one of choices 408 is an image 708C (FIG. 7) showing Abby having more balloons than Zip, and correct flag 410 (FIG. 4) of that choice indicates that the choice is correct. Thus, in step 608 (FIG. 6), lesson execution logic 304 causes I/O logic 306 (FIG. 3) to present prompt 406 (FIG. 4) and content 412 of choices 408 of the subject prerequisite concept to the student.

In step 610 (FIG. 6), lesson execution logic 304 receives a response from the student, e.g., data indicating which of choices 408 were selected by the student, through I/O logic 306 (FIG. 3), ASR logic 308, and NLP logic 310 as canonical text response 314 in the manner described above.

In test step 614 (FIG. 6), lesson execution logic 304 determines whether the one of choices 408 (FIG. 4) selected by the student is correct as indicated by correct flag 410. If the student has selected the correct choice, processing transfers to step 614 (FIG. 6) in which lesson execution logic 304 removes the subject prerequisite concept from the list of prerequisite concepts initialized in step 602. Thus, once the student has correctly understood prompt 406, including use of a term of the subject academic language therein, the student is no longer tested on that concept.

Conversely, if the student has selected an incorrect choice, processing by lesson execution logic 304 skips step 614 and the subject prerequisite concept remains in the list of prerequisite concepts. Thus, the student will be tested again on the same concept until the student properly understands the concept. In this illustrative embodiment, lesson execution logic 304 selects the same concept in the next performance of step 606 and, in the next performance of step 608, disables the choice made incorrectly by the student.

In either case, processing transfers through next step 616 to loop step 604 and lesson execution logic 304 repeats the loop of steps 604-616 until the student has correctly answered all of the prerequisite concepts of the list initialized in step 602.

Once the student has correctly answered all of the prerequisite concepts of the list initialized in step 602, processing transfers from loop step 604 to loop step 618.

Steps 618-630 represent a second teaching phase and implement a teaching technique that is also modeled after the way people learn a natural language outside of school. This second teaching phase takes the form of an adventure story or game. The story includes a narrative through-line and, like a game, follows actions taken by the student. Similar to the first teaching phase, lesson execution logic 304 uses terms of the subject academic language in the absence of definitions for those terms.

Loop step 618 and next step 630 define a loop in which lesson execution logic 304 processes each of tasks 426 (FIG. 4) of the subject segment 416 according to steps 620-628 (FIG. 6). During each iteration of the loop of steps 618-630, the particular one of tasks 426 processed by lesson execution logic 304 is sometimes referred to as the subject task.

In step 620, lesson execution logic 304 plays story segment setup 428 (FIG. 4) of the subject task. Story segment setup 428 includes content to be presented to the student as a part of the narrative story represented by segments 416 collectively. Story segment setup 428 includes that portion of the narrative story to which prompt 430 and choices 432 pertain. In step 620, lesson execution logic 304 sends story segment setup 428 to I/O logic 306, which then sends story segment setup 428 to student device 104 (FIG. 1) to be presented to the student. For example, story segment setup 428 (FIG. 4) can include audiovisual data representing a video to be played to the student to show that the characters, Abby and Zip, are locked in a room and that the student must find a key to release them from the room.

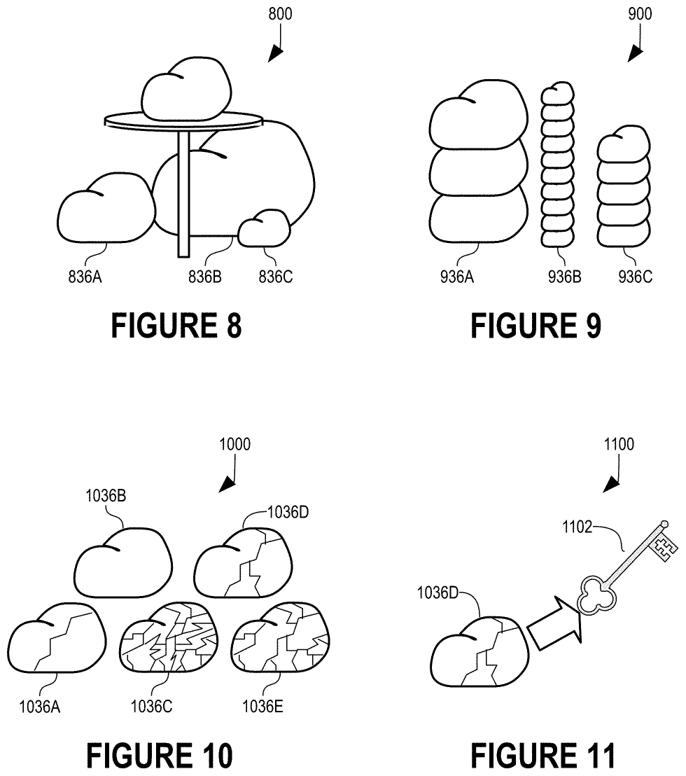

In step 622 (FIG. 6), lesson execution logic 304 presents prompt 430 (FIG. 4) to the student. Prompt 430 is directly analogous to prompt 406, and lesson execution logic 304 presents prompt 430 to the student in an analogous manner to that described above with respect to step 608 (FIG. 6). For example, prompt 430 can present a scene such as scene 800 (FIG. 8) and inform that student that the key is in the clump of clay that has a little more clay than the clump on the table. Presenting prompt 430 (FIG. 4) includes presenting content 436 of choices 432 to the student. Examples of content 436 include clumps 836A-C (FIG. 8) of clay.

In step 624 (FIG. 6), lesson execution logic 304 receives a response from the student in the manner described above with respect to step 610. In test step 626, lesson execution logic 304 determines whether the response received in step 624 is the correct response of the subject task.

If the response received in step 624 is not the correct response of the subject task, processing transfers from test step 626 to step 628 in which lesson execution logic 304 removes the incorrect response by the student. For example, if the student chose clump 836C, lesson execution logic 304 can show clump 836C broken into pieces with no key inside. From step 628, processing by lesson execution logic 304 transfers to step 622 and lesson execution logic 304 presents prompt 430 (FIG. 4) to the student again. In some embodiments, lesson execution logic 304 skips step 628, transferring directly to step 622 if the response received in step 624 is not the correct response of the subject task.

If the response received in step 624 is the correct response of the subject task, processing transfers from test step 626 through next step 630 to loop step 618 and lesson execution logic 304 processes the next of tasks 426 according to the loop of steps 618-630.

As described above, the sequence of tasks 426 collectively tell a narrative story that is the substantive content of the subject segment of lesson story 414. Continuing in this illustrative example, upon selection of the correct choice—clump 836A—by the student, story segment setup 428 of the next of tasks 426 includes a video showing clump 836A transform into three (3) piles 936A-C (FIG. 9) of clumps of clay in scene 900. Prompt 430 (FIG. 4) of this task informs the student that the key is in the pile with the most clumps of clay.

Upon the student's selecting of the correct choice of pile 936B, story segment setup 428 of the next task shows transformation of pile 936B into clumps 1036A-E (FIG. 10) of scene 1000. Prompt 430 of the next task can inform the student that the key is in the clump of clay with just a few cracks. The process continues to reveal a key 1102 (FIG. 11) in scene 1100 when the student chooses clump 1036D, at which point processing of tasks 426 (FIG. 4) in this illustrative example by lesson execution 304 according to steps 618-630 (FIG. 6) completes, as does processing according to logic flow diagram 504, and therefore step 504 (FIG. 5).

Thus, lesson execution logic 304 first introduces terms of an academic language in a first teaching phase of steps 602-616 and then reinforces understanding of those terms in an adventure game of a second teaching phase of steps 618-630. The result is effective, efficient, and scalable teaching of the academic language.

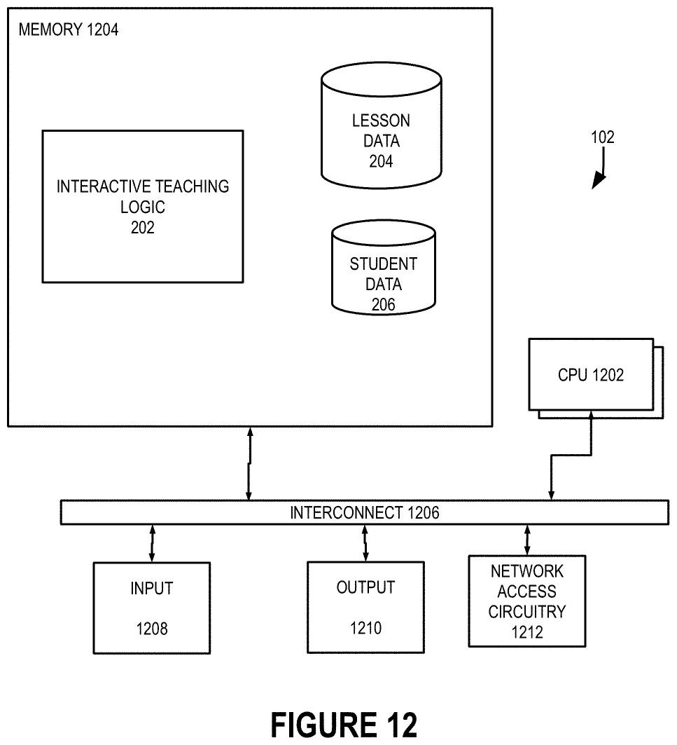

Teaching server 102 is shown in greater detail in FIG. 12. As noted above, it should be appreciated that the behavior of teaching server 102 described herein can be distributed across multiple computer systems using conventional distributed processing techniques. Teaching server 102 includes one or more microprocessors 1202 (collectively referred to as CPU 1202) that retrieve data and/or instructions from memory 1204 and execute retrieved instructions in a conventional manner. Memory 1204 can include generally any computer-readable medium including, for example, persistent memory such as magnetic and/or optical disks, ROM, and PROM and volatile memory such as RAM.

CPU 1202 and memory 1204 are connected to one another through a conventional interconnect 1206, which is a bus in this illustrative embodiment and which connects CPU 1202 and memory 1204 to one or more input devices 1208, output devices 1210, and network access circuitry 1212. Input devices 1208 can include, for example, a keyboard, a keypad, a touch-sensitive screen, a mouse, a microphone, and one or more cameras. Output devices 1210 can include, for example, a display—such as a liquid crystal display (LCD)—and one or more loudspeakers. Network access circuitry 1212 sends and receives data through computer networks such as WAN 110 (FIG. 1). Server computer systems often exclude input and output devices, relying instead on human user interaction through network access circuitry. Accordingly, in some embodiments, teaching server 102 does not include input devices 1208 and output devices 1210.

A number of components of teaching server 102 are stored in memory 1204. In particular, interactive teaching logic 202 is all or part of one or more computer processes executing within CPU 1202 from memory 1204. As used herein, “logic” refers to (i) logic implemented as computer instructions and/or data within one or more computer processes and/or (ii) logic implemented in electronic circuitry.

Lesson data 204 and student data 206 are each data stored persistently in memory 1204 and can be implemented as all or part of one or more databases.

It should be appreciated that the distinction between servers and clients is largely an arbitrary one to facilitate human understanding of purpose of a given computer. As used herein, “server” and “client” are primarily labels to assist human categorization and understanding.

While this invention has been described in terms of several embodiments, there are alterations, modifications, permutations, and substitute equivalents, which fall within the scope of this invention. Although sub-section titles may have been provided to aid in the description of the invention, these titles are merely illustrative and are not intended to limit the scope of the present invention. It should also be noted that there are many alternative ways of implementing the methods and apparatuses of the present invention. The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

What is claimed is:

1. A computer implemented method for teaching a human student fluency in an academic language, the method comprising:
for each of two or more terms of the academic language:
presenting a prompt to the student wherein the prompt uses the term without defining the term;
receiving a response from the student that is responsive to the prompt; and
determining that the student understands the term upon a condition in which the response represents a correct understanding of the term;
for each of two or more segments of a narrative story that uses the two or more terms:
presenting story content of the segment;
presenting one or more segment prompts of the segment using the terms to the student;
for each of the segment prompts, receiving corresponding segment responses; and
upon a condition in which all of the segment responses represent correct understanding of the terms, progressing the narrative story to the next segment.

2. The method of claim 1 wherein the prompt is associated with two or more responsive choices.

3. The method of claim 2 wherein the response represents a selection by the student of a selected one of the responsive choices.

4. The method of claim 3 further comprising:
disabling the selected responsive choice for subsequent response by the student upon a condition in which the selected responsive choice is incorrect for the prompt.

5. The method of claim 1 wherein each of the segment prompts is associated with two or more responsive segment choices.

6. The method of claim 5 wherein the response represents a selection by the student of a selected one of the responsive segment choices.

7. The method of claim 6 further comprising:
disabling the selected responsive segment choice for subsequent response by the student upon a condition in which the selected responsive segment choice is incorrect for the segment prompt.

8. A non-transitory computer readable medium useful in association with a computer which includes one or more processors and a memory, the computer readable medium including computer instructions which are configured to cause the computer, by execution of the computer instructions in the one or more processors from the memory, to teach a human student fluency in an academic language by at least:
for each of two or more terms of the academic language:
presenting a prompt to the student wherein the prompt uses the term without defining the term;
receiving a response from the student that is responsive to the prompt; and
determining that the student understands the term upon a condition in which the response represents a correct understanding of the term;
for each of two or more segments of a narrative story that uses the two or more terms:
presenting story content of the segment;
presenting one or more segment prompts of the segment using the terms to the student;
for each of the segment prompts, receiving corresponding segment responses; and
upon a condition in which all of the segment responses represent correct understanding of the terms, progressing the narrative story to the next segment.

9. The computer readable medium of claim 8 wherein the prompt is associated with two or more responsive choices.

10. The computer readable medium of claim 9 wherein the response represents a selection by the student of a selected one of the responsive choices.

11. The computer readable medium of claim 10 wherein the computer instructions are configured to cause the computer to teach a human student fluency in an academic language by at least also:
disabling the selected responsive choice for subsequent response by the student upon a condition in which the selected responsive choice is incorrect for the prompt.

12. The computer readable medium of claim 8 wherein each of the segment prompts is associated with two or more responsive segment choices.

13. The computer readable medium of claim 12 wherein the response represents a selection by the student of a selected one of the responsive segment choices.

14. The computer readable medium of claim 13 wherein the computer instructions are configured to cause the computer to teach a human student fluency in an academic language by at least also:
disabling the selected responsive segment choice for subsequent response by the student upon a condition in which the selected responsive segment choice is incorrect for the segment prompt.

15. A computer system comprising:
a processor;
a computer readable medium operatively coupled to the processor; and
academic language teaching logic (i) that executes in the processor from the computer readable medium and (ii) that, when executed by the processor, causes the computer to teach a human student fluency in an academic language by at least:
for each of two or more terms of the academic language:
presenting a prompt to the student wherein the prompt uses the term without defining the term;
receiving a response from the student that is responsive to the prompt; and
determining that the student understands the term upon a condition in which the response represents a correct understanding of the term;
for each of two or more segments of a narrative story that uses the two or more terms:
presenting story content of the segment;
presenting one or more segment prompts of the segment using the terms to the student;
for each of the segment prompts, receiving corresponding segment responses; and
upon a condition in which all of the segment responses represent correct understanding of the terms, progressing the narrative story to the next segment.

16. The computer system of claim 15 wherein the prompt is associated with two or more responsive choices.

17. The computer system of claim 16 wherein the response represents a selection by the student of a selected one of the responsive choices.

18. The computer system of claim 17 wherein the academic language teaching logic, when executed by the processor, causes the computer to cause the computer to teach a human student fluency in an academic language by at least also:
disabling the selected responsive choice for subsequent response by the student upon a condition in which the selected responsive choice is incorrect for the prompt.

19. The computer system of claim 15 wherein each of the segment prompts is associated with two or more responsive segment choices.

20. The computer system of claim 19 wherein the response represents a selection by the student of a selected one of the responsive segment choices.

21. The computer system of claim 20 wherein the academic language teaching logic, when executed by the processor, causes the computer to cause the computer to teach a human student fluency in an academic language by at least also:
disabling the selected responsive segment choice for subsequent response by the student upon a condition in which the selected responsive segment choice is incorrect for the segment prompt.
